(19) United States
(12) Patent Application Publication
(10) Pub. No.: US 2004/0264704 A1
(43) Pub. Date: Dec. 30, 2004

(54) Graphical user interface for determining speaker spatialization parameters

(76) Inventors: Camille Huin, Cambridge, MA (US); Miguel A. Chavez, Cambridge, MA (US); Jesse Remignanti, Reading, MA (US)

Correspondence Address: John J. Stickevers, Bromberg & Sunstein LLP, 125 Summer Street, Boston, MA, 02110-1618, US

(21) Appl. No.: 10/865,564

(22) Filed: Jun. 10, 2004

Related U.S. Application Data
(60) Provisional application No. 60/478,902, filed on Jun. 13, 2003.
(60) Provisional application No. 60/478,550, filed on Jun. 13, 2003.

(51) Int. Cl. H04R 29/00; H04R 5/00

(52) U.S. Cl. 381/59; 381/18

(57) ABSTRACT

A system for determining speaker spatialization parameters. The system includes a graphical interface allowing a user to select a number of listeners, number of speakers, and a listening space and for graphically displaying on a display device the one or more listeners and one or more speakers within the listening space. The system further includes a speaker spatialization module for determining one or more speaker spatialization parameters based upon the relative positions on the display device of the one or more listeners and the one or more speakers within the listening space system. The user may reposition the speakers and for each speaker that is repositioned the speaker spatialization module recalculates the speaker spatialization parameters for that speaker. The user may also graphically reposition one of the listeners and the speaker spatialization module recalculates all of the speaker spatialization parameters for all of the speakers.

The present U.S. Patent Application claims priority from U.S. Provisional Patent Application No. 60/478,902 entitled “Graphical Computer Programming” bearing attorney document number 2550/178 filed on Jun. 13, 2003, which is incorporated herein by reference in its entirety. The present U.S. Patent Application also claims priority from U.S. Provisional Patent Application No. 60/478,550 entitled “Graphical User Interface for Determining Speaker Spatialization Parameters,” bearing attorney document number 2550/179, filed on Jun. 13, 2003. The present U.S. Patent Application is related to U.S. Patent Application _________ entitled “Graphical Computer Programming for a Digital Signal Processor,” bearing attorney document number 2550/180, U.S. Patent Application _________ entitled “Stack and Repeating Graphical Control,” bearing attorney document number 2550/181, and U.S. Patent Application entitled “Graphical Computer Programming,” bearing attorney docket number 2550/A26, which are filed concurrently herewith and incorporated herein by reference in their entirety.

### TECHNICAL FIELD AND BACKGROUND ART

The present invention relates to audio signals and more specifically to graphical tools for controlling audio signals.

It is known in the prior art to provide a fader and balance controls in the headset of an automobile radio. The fader and balance controls allow a driver to adapt the sound based upon the driver's perception. In an American car, the driver is positioned on the left side of the interior of the car. Auto manufacturers normally place two or more speakers within the interior of the car and each speaker is generally associated with a channel. In a simple two speaker example, a right speaker and a left speaker are mounted to the doors of the car. Since the driver is positioned on the left side of the car, the driver may wish to compensate for his proximity to the left speaker by decreasing the signal level of the left channel while increasing the signal level of the right channel. If more than one person is in the car, compensation of the level for a channel may differ. In cars that have radios that have fader and balance controls, the signal levels of the channels are changed in accordance with the listener's perception.

It would be preferable to have an automated system that allows a listener of music in an environment to select a compensation scenario that adjusts one or more parameters effecting the spacialization of the audio signal that is based on some empirical results. Further, it would be desirable to have a system that allows for configuring a processor that is part of the audio system. Further still, it would be desirable to have a system that provides a graphical user interface for determining parameter values associated with each channel of a multi-channeled audio system.

### SUMMARY OF THE INVENTION

A system for determining speaker spatialization parameters is described. The system includes a graphical interface allowing a user to select a number of listeners, number of speakers, and a listening space and for graphically displaying on a display device the one or more listeners and one or more speakers within the listening space. The system further includes a speaker spatialization module for determining one or more speaker spatialization parameters based upon the relative positions on the display device of the one or more listeners and the one or more speakers within the listening space system.

A user can define the dimensions of the listening space. For example, the user may be able to input actual dimensions for the listening space, such as the length and width. In other embodiments, the user may be provided with a set of pre-defined listening spaces, such as, small, medium and large, each having a different set of associated dimensions. The system allows the user to position one or more listeners within the graphically displayed listening space. Similarly, the system allows the user to position one or more speakers graphically within the listening space. The user may then reposition the speakers and for each speaker that is repositioned the speaker spatialization module recalculates the speaker spatialization parameters for that speaker. The speaker spatialization parameters may include gain and also delay. The user may also graphically reposition one of the listeners and the speaker spatialization module recalculates all of the speaker spatialization parameters for all of the speakers.

The distances between the speakers, the listeners and the listening space (as defined by the shape of the listening space) correspond to proportional spatial distances between physical speakers and real listeners in a physical listening space. The speaker spatialization parameters can be saved in memory for later use with a digital signal processor in an audio system. For example, the speaker spatialization parameters can be ported to a digital signal processor in an automobile wherein the speaker spatialization parameters are determined solely by using the graphical interface and virtual listening space.

The system can also be attached to a digital signal processor wherein the speaker spatialization parameters are sent to the digital signal processor. In such an embodiment, the parameters are calculated in real-time. The digital signal processor may be electrically coupled to an amplifier and one or more speakers and the digital signal processor can process an audio input signal from an audio source and provide an audio output to the amplifier. The audio output is amplified and then presented to the speakers which produce an acoustical signal which can be listened to one or more listeners. Thus, by making changes in the graphical domain of the system to the positions of the speakers and the listeners, a user of the system can test how the system will actually sound without having to physically move the speakers.

In certain embodiments, the speaker spatialization module includes a spatial model of the listening space accounting for room reflection and absorption properties that is used in calculating the spatialization parameters. The speaker spatialization module may use a three dimensional model for the listening space. In other embodiments, a psycho-acoustical model is used.

In certain embodiments, the dimensions of the listening space can be changed causing the speaker spatialization parameters to be recalculated. Both the graphical interface and the speaker spatialization module may be implemented in computer code to form a computer program.

### BRIEF DESCRIPTION OF THE DRAWINGS

The foregoing features of the invention will be more readily understood by reference to the following detailed description, taken with reference to the accompanying drawings, in which:

FIG. 1 is an environment for employing one embodiment of the present invention;

FIG. 2 is a block diagram showing the inputs and outputs that are determined;

FIG. 3 shows a graphical display that shows multiple speaker configurations and there positions;

FIG. 4 is a graphical display that a user may encounter when initializing the system;

FIG. 5 is a flow chart showing the steps that are used in adapting the spatialization of an audio system.

FIG. 6 is a screen shot showing the virtual environment upon initialization; and

FIG. 7 is a screen shot showing the virtual environment once a number of speakers have been added to the virtual environment of FIG. 6.

### DETAILED DESCRIPTION OF SPECIFIC EMBODIMENTS

Definitions. As used in this description and the accompanying claims, the following terms shall have the meanings indicated, unless the context otherwise requires. A channel is defined as the audio signal path between an amplifier and a loudspeaker. An audio system is defined as multiple channels driven by an audio source. An audio source is any electronic device that generates one or multiple signals representative of a sound or multiple sounds. An adjustment parameter is a variable that can be changed such as the level of the audio signal or the delay of the audio signal in a channel. The adjustment parameter may be any variable that has an effect on sound spacialization.

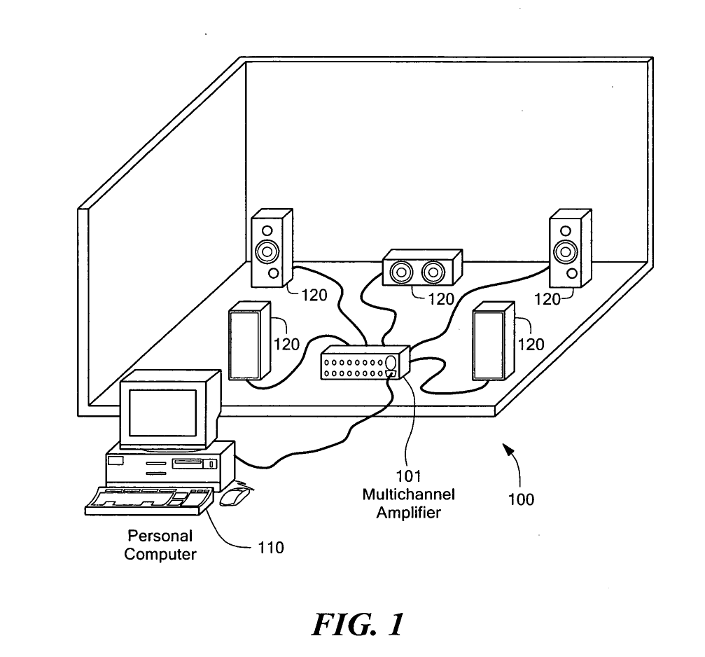

FIG. 1 shows an environment 100 for implementing the present invention. A computer runs a graphical program having a graphical interface for allowing a user to input information about speaker configuration in a multiple channel audio system. In FIG. 1 is shown a multi-channel amplifier 101 that is in communication with the personal computer 110. The multi-channel amplifier 101 provides a gain increase to an input audio signal for each channel. The amplified signal is then provided to a speaker. In the present example, a distinct audio signal is provided to each of the five speakers 120. The multi-channel amplifier is coupled to a pre-amplifier and to an audio source (not shown). The audio source provides one or more audio signals to the pre-amplifier and the pre-amplifier provides five discrete audio signals to the multi-channel amplifier.

The personal computer 110 is electrically coupled to a signal processor (not shown) that is part of the audio system wherein the signal processor can be programmed and the signal processor is capable of receiving parameters as inputs that can be used with a program that runs on the signal processor for effecting the spatialization of an audio signal. In the following description the signal processor will be designated as a digital signal processor for convenience, but it should be understood that the signal processing that occurs in the system may be digital, analog or digital and analog. The digital signal processor is preferably part of the pre-amplifier section of the audio system. In such a configuration, the digital signal processor changes the audio signal that is passed to each audio channel independently. For example, a parameter such as the signal level or a delay may be imposed on one of the five channels of the audio system, thus changing the spatialization of the audio signal to a listener of the audio system.

In one embodiment of the present invention, a graphical user interface shows a representation of the speakers and their location with respect to a listener position. In the initial setup of the graphical user interface, a user of the system inputs the number of speakers to be used, the physical position of each speaker, and the physical position of the listener. The user may also be requested to enter the physical size of the listening space or the dimensions of the listening space. Although FIG. 1 shows an audio system within a room, it can be imagined that the current invention can be used in any of a multitude of environments, including within cars. With the graphical user interface, a user of the system can virtually change the position of a speaker, wherein one or more parameter values are changed in response to the change in position of the speaker within the graphical representation. As such there is a correspondence between the physical world and the graphical representation wherein movement between two points in the graphical representation corresponds to changes in position within the physical world. A user of the graphical interface can select a speaker and reposition the speaker in the graphical environment. As the speaker position is changed in the graphical environment, a parameter value is calculated such that once it is provided to the DSP and an audio signal is passed through the DSP and played through the speaker, the sound that is produced will simulate the change in speaker position that were done graphically. The parameter value which is determined changes the spatialization of the audio signal so that the physical system simulates the virtual system that is displayed on the graphical user interface. In such a configuration, the physical speakers are not moved.

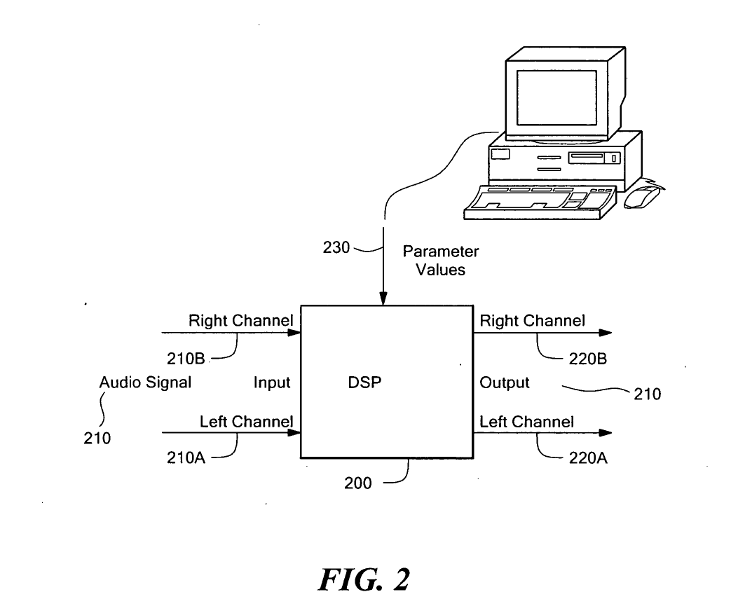

FIG. 2 illustrates the inputs and the outputs to each channel within the audio system. For example, as shown in the figure, a stereo signal 210 is input wherein there is a left channel audio signal 210A and a right channel audio signal 210B. The left channel audio signal 210A is processed in the digital signal processor 200 wherein input parameters 230 are passed to the digital signal processor 200 from the computer program that is controlled by the graphical user interface, which results in a left channel output signal 220A. The left channel output signal 220A is a modified version of the input signal. Similarly, the right channel audio signal 210B is passed into the digital signal processor 200 and based in part upon the parameter values 230 that are passed from the computer system; the digital signal processor processes the right channel audio signal 210B creating a right channel audio output signal 220B that is a modified version of the input signal.

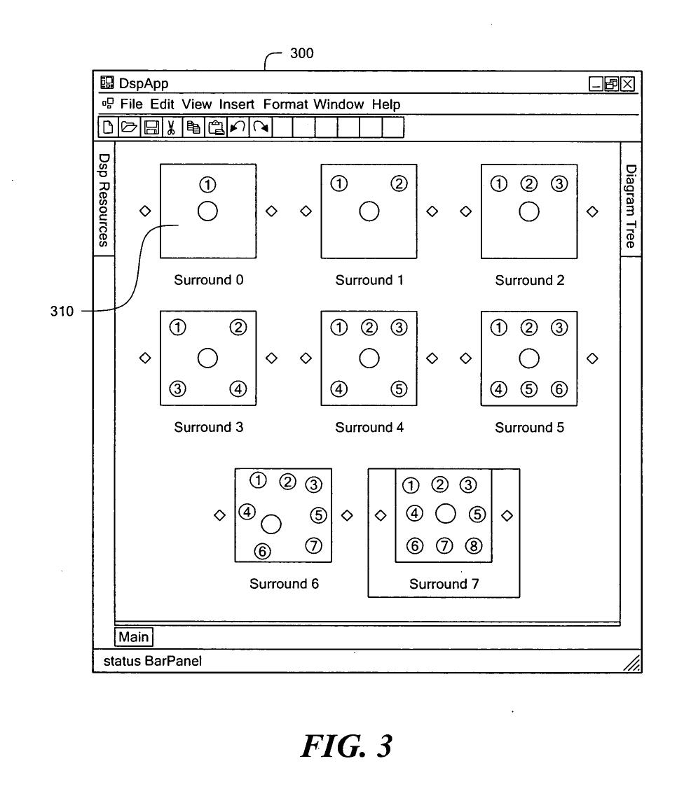

FIG. 3 shows various graphical user interfaces 300 with various speaker configurations. The speaker configurations range from a surround sound system of 1 which includes 1 speaker to a surround sound system of 7 which includes 7 speakers. As previously stated, each speaker is provided with its own independent audio signal which is independently modified. As shown in surround sound system 0 there is one speaker which is located at the position marked with a 1. The listener 310 is marked at the position of the dot in the center of the graphical display. This display is the result of the user inputting information about the size of the listening space, the location of the speaker within the listening space and the position of the listener within the listening space. In the present example, the graphical representation of the listening space is a two dimensional representation, but the graphical representation could be adapted to a third dimension. In a three dimensional model room reverberation would be a factor, as well as early (direct) and late (indirect) reflections. The three dimensional model may be expanded to take into account real-acoustical space models. For example, a space model of a car may take into account the reflection and absorption of sound from the exact materials that make up a particular automotive model. Further, the listener's head position and the real speaker response and direction patterns such as specific polar plots measured for all speaker positions may be used in calculating parameter values. The parameter values can be saved in memory and later ported to a digital signal processor that operates with a physical audio system. The graphical interface allows for parameter values to be calculated without having to have either an audio system or a digital signal processor coupled to the computer running the software program.

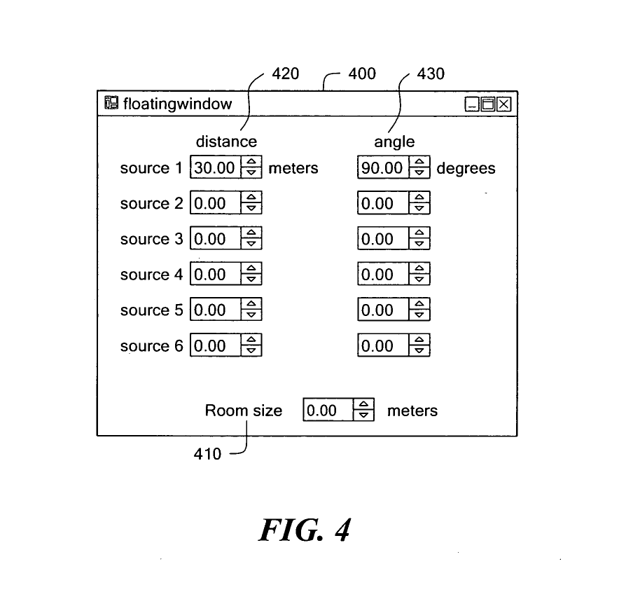

FIG. 4 shows a graphical screen 400 that a user may encounter upon beginning the software program. The graphical screen 400 allows the user to enter relevant information before making adjustments to the location of the speakers or to the location of the listeners. In one embodiment as shown, the user inputs the room size 410 in terms of meters and also includes the location of the speakers 420 in terms of meters and also the angle of the speakers in terms of degrees 430. The distance for the speakers and the angle of the speakers is with respect to a reference point which could be, for example, at the forward center-most position of the room. By changing the room size, a user of the system can implement different spaces using the same locations for the speakers. For example, a user may select a small room with all of the speakers in the front of the room and then may add in a dimension which would increase the size of the room to that of a concert hall with all of the speakers positioned at the same location in the front of the hall. In this event parameter values for the spatialization would be determined for all of the channels.

The user of the system can then change the position of a speaker. The computer program calculates out a parameter for that channel. Equations for calculating the parameter values may be inferred from such texts as Beranek, Acoustics (McGraw-Hill 1954) and Olsen, Modern Sound Reproduction (Van Nostrand Reinhold, New York 1972) which explains acoustical equations. Both texts are incorporated herein by reference in their entirety. In different embodiments, a psycho-accoustical model may be employed to calculate the parameters including a volume and delay. Texts such as Zwicker, Psychoacoustics (Springer-Verlag Berlin 1990), Pohlman, Principles of Digital Audio (McGraw-Hill 3^{rd} Ed. 1995), and Roederer, The Physics of Psychophysics of Music (Springer-Verlag Alaska 3^{rd}. Ed. 1995) may be used to show psychoacoustic equations for determining parameter values and each text is incorporated herein by reference in its entirety. The parameter may be passed directly to the coupled digital signal processor or the parameter can be calculated for later download or transfer to the digital signal processor. As previously stated, more than one parameter may be calculated and used for a channel, for example the volume level (gain) and the delay. In one embodiment, in which the parameter is passed in real-time, the computer system may employ the system described in the patent application entitled “Graphical Computer Programming” filed concurrently herewith and bearing attorney docket number 2550/A26. This application is incorporated herein by reference in its entirety.

The system can be configured to calculate the ideal listening parameters for one or more listeners. For example, more than one listener icons can be placed within the graphical environment to simulate multiple listeners. The system will then determine the proper parameters for each speaker, so that the sound spatialization appears to be balanced to each listener.

As previously stated, parameter values are calculated and can then be passed in real-time to a digital signal processor. The parameter values may be calculated as follows. Since the speed of sound is considered to be a fixed parameter and speed is calculated as speed=distance/time, the delay in terms of time can be calculated with respect to the change in distance. For example, the speed of sound at 20 degrees Celsius is assumed to be 343 m/s. If the change in distance is 1 m then the delay should be 1/343 sec. With respect to gain/volume, the gain is related to distance such that y=A*(x). For a change between actual distance and the desired distance, the gain can be calculated in terms of dBs as gain=20 log 10 (actual distance/desired distance). For example if the actual distance is 1 meter than the attenuation at 2 meters is 20*log 10(½)=−6.02 dB.

If multiple listeners are present, the same equations can be employed, but with a different weighting factor for each listener. The weighting factors are used for calculating the spatialization parameter values. Thus, as compared to the ideal situation for a single listener, an attempt may be made to balance the parameter values such that the each listener has near ideal speaker spatialization.

Although the equations are simply calculated in the above examples that are provided, the equations may take into account additional parameters such as the volume of the listening space (ft³), the physical dimensions of the listening space, the number of listeners, the temperature of the air, the air pressure, different mediums (water, helium, etc), etc.

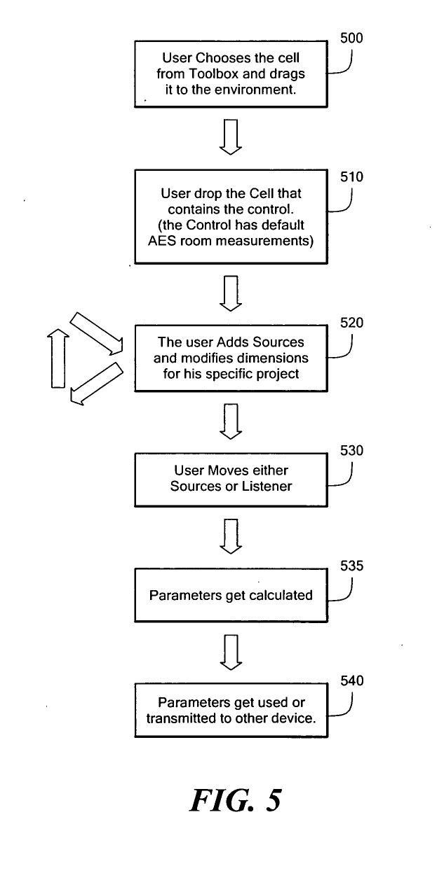

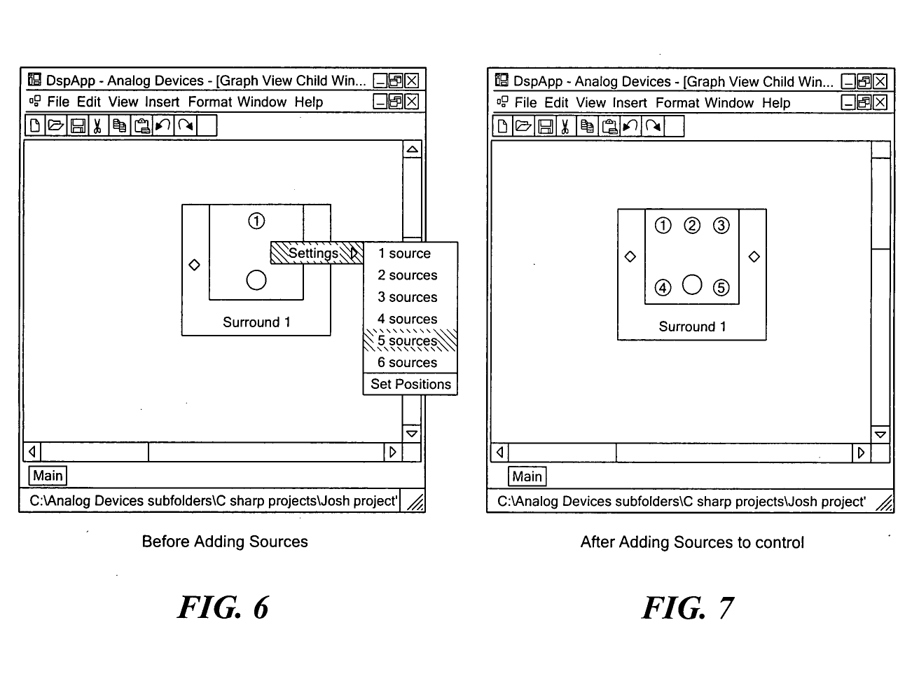

FIG. 5 is a flowchart showing the steps taken using the graphical user interface in a graphical programming environment with a coupled digital signal processor for determining parameter values for adjusting the spatialization of an audio signal. First a user selects a cell from a toolbox within the graphical programming environment that represents an audio room 500. Once the cell, which is a graphic, is dropped into the workspace, a virtual environment is initialized 510 see also the screen shoot of FIG. 6. The initial environment defines a listening space, along with the numbers of users and the numbers of speakers. The system may default to AES (Audio Engineer Society) room measurements and the cell may default with one speaker and one listener within the listening space. The user is then provided with a screen, which may be accessed by using a pointing device and selecting the cell which will allow the user to add additional sound sources (speakers) and additional listeners to the listening space 520. The user will be allowed to modify the dimension of the space and modify the number of sound sources and the relative position of the sound sources. This step may be repeated multiple times, allowing the user to add in additional sound sources and listeners. The user of the system attempts to duplicate the position of listeners and of speakers in the physical world within the virtual environment. FIG. 7 shows a screen shot of the virtual environment after speakers have been added to the virtual environment when compared to FIG. 6. Once all of the listeners and sound sources are positioned initially, the user may then move either the speakers or a listener 530. When a speaker is moved one or more parameter values are calculated for that speaker. If a listener is moved, parameter values are calculated for each speaker 535. The parameter values, once calculated, are then transferred from the graphical programming environment to a storage location for later use or are sent to a digital signal processor where the parameters are used as variables within the digital signal processor for altering the input audio signal of each channel to produce output audio signal which are in turn transferred to an audio amplifier and then to a speaker 540. The audio signal is then made audible to the user of the system. The user of the system may then make adjustments to the system based upon the user's perception of the audio signal while using the visual display from the virtual environment to provide additional information regarding the spatialization. The user can then adjust the virtual environment so that they reflect the sound that is desired from the physical world.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A system for determining speaker spatialization parameters, the system comprising:
a graphical interface allowing a user to select a number of listeners, number of speakers, and a listening space and for graphically displaying on a display device the one or more listeners and one or more speakers within the listening space;
a speaker spatialization module for determining one or more speaker spatialization parameters based upon the relative positions on the display device of the one or more listeners and the one or more speakers within the listening space system

2. A system according to claim 1, wherein the graphical programming environment allows a user to define dimensions of the listening space.

3. A system according to claim 1, wherein the graphical programming environment allows a user to position the one or more listeners within the listening space.

4. A system according to claim 3, wherein the graphical programming environment allows a user to position the one or more speakers within the listening space.

5. A system according to claim 4 wherein the speaker spatialization module recalculates the speaker spatialization parameters for each speaker that is repositioned by a user.

6. A system according to claim 4 wherein the speaker spatialization module recalculates the speaker spatialization parameters for all of the speakers if a listener is repositioned by the user.

7. A system according to claim 1, wherein distances between the one or more speakers, the one or more listeners and the listening space as represented on display device correspond to proportional spatial distances between physical speakers, real listeners and a physical listening space.

8. The system according to claim 1, wherein the speaker spatialization parameters for each speaker includes gain and delay.

9. The system according to claim 7, wherein the speaker spatialization module further includes a spatial model of the listening space accounting for room reflection and absorption properties that is used in calculating the spatialization parameters.

10. The system according to claim 1, wherein the speaker spatialization module uses a three dimensional model accounting fro room reverberations and reflections in calculating the spatialization parameters.

11. The system according to claim 1, further comprising:
a digital signal processor, wherein the digital signal processor receives the speaker spatialization parameters from the speaker spatialization module and processes an input audio signal according to the speaker spatialization parameters producing an audio output signal.

12. The system according to claim 10, further comprising:
an audio amplifier electrically coupled to the digital signal processor; and
at least one speaker electrically coupled to the audio amplifier,
wherein the audio amplifier receives the audio output from the digital signal processor and provides the amplified audio output to the one or more speakers.

13. The system according to claim 1, wherein a user can change dimensions of the listening space, and when the dimension of the listening space are changed, the spatialization parameters are recalculated by the speaker spatialization module.

14. The system according to claim 1, wherein the speaker spatialization module uses a psycho-acoustical model to calculate the speaker spatialization parameters.

15. The system according to claim 12 wherein the speaker spatialization parameters are calculated in real-time.

16. A computer program product having computer code thereon for determining speaker spatialization parameters using a computer system, the computer code comprising:
computer code for allowing selection of a cell representative of an audio space in a graphical workspace;
computer code for providing a selection screen allowing a user to select a total number of speakers;
computer code for providing a selection screen allowing a user to select a total number of listeners;
computer code for graphically displaying the audio space with the selected number of speakers and the selected number of listeners on a display device;
computer code for calculating speaker spatialization parameters for each speaker based at least upon the selected audio space, the selected number of listeners, and the selected number of speakers.

17. The computer program product according to claim 16, wherein the computer code for calculating the speaker spatialization parameters bases the calculation in part on the relative position of the selected speakers and the selected listeners on the display device.

18. The computer program product according to claim 17, wherein the relative position of the selected speakers and the selected listeners on the display device is proportional to actual physical dimensions.

19. The computer program product according to claim 16, further comprising:
computer code for allowing a user to graphically select a speaker and reposition the speaker, wherein speaker spatialization parameters for the repositioned speaker are recalculated.

20. The computer program product according to claim 16, further comprising:
computer code for allowing a user to graphically select a listener and reposition the listener, wherein the speaker spatialization parameters for each speaker are recalculated.
